(19) United States
(12) Patent Application Publication
(10) Pub. No.: US 2022/0341453 A1
(43) Pub. Date: Oct. 27, 2022

(54) Fastener with Integral Seal

(71) Applicant: Illinois Tool Works Inc., Glenview, IL (US)

(72) Inventor: Mark O. Lepper, Oak Park, IL (US)

(21) Appl. No.: 17/705,652

(22) Filed: Mar. 28, 2022

Related U.S. Application Data
(60) Provisional application No. 63/179,771, filed on Apr. 26, 2021.

(51) Int. Cl. F16B 19/00

(52) U.S. Cl. CPC F16B 19/008

(57) ABSTRACT

Disclosed are systems and methods for coupling a first panel to a second panel via a fastening system, such as a pin and grommet (P&G) fastener having a grommet and a fastener assembly. The fastener assembly includes a rigid part component and a flexible seal that is integrally coupled with the rigid part component at an interface. The flexible seal is fabricated from a first material and the rigid part component is fabricated from a second material that is different from the first material. The interface defines one or more dovetails or other features to interlock the flexible seal with the rigid part component.

### CROSS-REFERENCE

The present application claims the benefit under 35 U.S.C. § 119(e) of U.S. Provisional Patent Application No. 63/179,771, filed Apr. 26, 2021, and entitled “2K Dovetail Interface,” the contents of which are hereby incorporated by reference.

### BACKGROUND

Automotive components require fastening techniques that are simple to manufacture and assemble. Further, fastening techniques should above all be reliable and efficient. In order to secure a secondary panel to a primary panel, a fastener may be used, such as a pin and grommet fastener.

In some examples, the fastener may include a seal to seal the opening in the secondary panel. The seal may be fabricated from a seal material that is different from the fastener material used to fabricate the rigid portions of the fastener (e.g., a fastener stem, head, etc.). The seal material improves effectiveness of the seal, but requires a step of connecting the seal with the fastener prior to use. If this is done with a secondary, post-molding operation, the seals could becoming separated from the fastener stem during shipping and handling. It is also labor intensive to connect the seals with the fastener just before installation. Therefore, it is advantageous to provide a fastener where the seal is a seal integral with the head and/or stem of the fastener, but still fabricated using a seal material that enhances the sealing capabilities of the seal portion and is not of the same material as the other more rigid parts of the head and of the stem. Commonly owned U.S. Pat. No. 6,752,950 to Martin D. H. Clarke, which is entitled “Two Shot Molding Method And Fastener Clip With Seal Made Thereby”, discloses a two shot molding method to make a fastener device having a fastener portion and integral seal portion of different material.

Despite various advancements to date, it would nevertheless be desirable to provide a fastener having a fastener portion and integral seal portion with improved retention characteristics between the fastener portion and integral seal portion.

### SUMMARY

The present disclosure relates generally to a fastening system to form a blind connection between the panels, such as automotive panels, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIGS. 1a and 1b illustrate, respectively, disassembled and assembled side views of example fastening systems configured to form a blind connection between panels in accordance with aspects of this disclosure.

FIGS. 2a and 2b illustrate, respectively, a top and bottom isometric views of the fastening system of FIG. 1a and 1b in accordance with aspects of this disclosure.

FIG. 2c illustrates a side view of the fastening system of FIG. 1a and 1b.

FIG. 2d illustrates an assembly view of the fastening system of FIG. 1a and 1b showing the first fastener component and the second fastener component in accordance with aspects of this disclosure.

FIG. 3a illustrates a bottom isometric view of the first fastener component of FIG. 1a and 1b.

FIG. 3b illustrates a bottom isometric view of the shaft portion of the first fastener component with the seal removed.

FIG. 3c illustrates a top isometric view of the seal.

FIGS. 3d and 3e illustrate cross-sectional side views of the fastening system in an assembled position.

FIGS. 4a through 4f illustrate example non-circular cross-sections for the interface of the first fastener component in accordance with aspects of this disclosure.

FIG. 5 illustrates an example method for forming a fastener assembly with an integrated flexible seal using a molding tool during a two-shot manufacturing process.

FIG. 6 illustrates a bottom isometric view of a tree fastener.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

A fastener can be used to form a connection between a first panel and a second panel, such as automotive panels. In one example, a fastener assembly for forming a sealed connection between a first panel and a second panel includes a rigid part component and a flexible seal that is integral with the rigid part component. The rigid part component is configured to retain the second panel relative to the first panel and fabricated from a part material. The rigid part component comprises a head portion configured to engage the first panel and a shaft portion extending from the head portion. The flexible seal is positioned at an interface adjacent the head portion to surround the shaft portion and is fabricated from a seal material that is different from the part material. The interface defines a non-circular cross-section.

In some examples, the non-circular cross-section includes at least one lobe, such as a dovetail. In some examples, the at least one lobe forms a longitudinal taper in a direction along a longitudinal axis defined by the shaft portion. In some examples, the first material or seal material is a foam material or an elastomeric material, while the second material or part material is a rigid synthetic or semi-synthetic polymer material.

The rigid part component and the flexible seal can be fabricated to form the fastener assembly via a two-shot injection process where the rigid part component conforms to and bonds with an inner interface surface of the flexible seal to define the interface. In an example, a method of fabricating a fastener assembly is provided using a molding tool having at least a part cavity defining a configuration of a rigid part component and a seal cavity defining a configuration of a flexible seal that are initially in flow communication with one another. Flow communication between said part cavity and said seal cavity is temporarily closed off via an injection core assembly where the injection core assembly is configured to open and close flow communication between said part cavity and said seal cavity. A first material is then injected into said seal cavity to mold the flexible seal of said fastener assembly, wherein the injection core assembly is shaped to define at least one lobe at an inner interface surface of the flexible seal. Flow communication between said part cavity and said seal cavity is then opened via the injection core assembly, a second material is then injected into said part cavity to form the rigid part component. The second material flows from the part cavity into intimate contact with the inner interface surface of the flexible seal as molded to form an interface between the rigid part component and the flexible seal. The fastener assembly is then ejected from the molding tool. The resulting fastener assembly as molded has parts of different materials molded sequentially together. In other examples, the flexible seal is over-molded onto the rigid part component to form the fastener assembly where the flexible seal conforms to and bonds with an outer interface surface of the rigid part component to define the interface.

In some examples, the rigid part component is a pin that is configured to engage the second panel via a second fastener component coupled thereto, such as a grommet configured to engage an opening formed in the second panel. For example, a pin and grommet (P&G) fastener for forming a sealed connection between a first panel and a second panel can include a fastener assembly and a grommet. The fastener assembly comprising a rigid part component and a flexible seal that is integrally coupled with the rigid part component at an interface. The flexible seal is fabricated from a first material and the rigid part component is fabricated from a second material that is different from the first material, where the rigid part component configured to retain the second panel relative to the first panel via the grommet, and the interface defines one or more dovetails to interlock the flexible seal with the rigid part component.

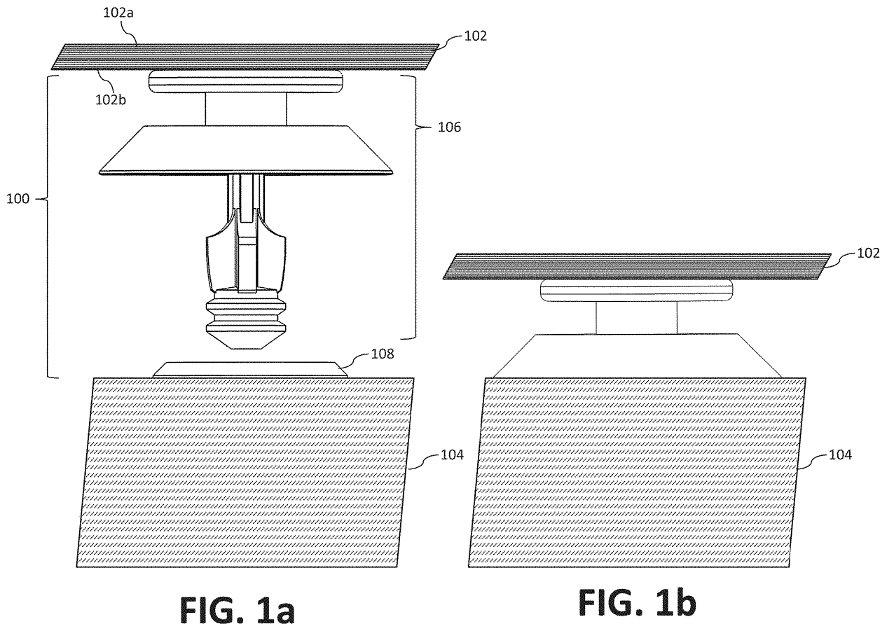

FIG. 1a and 1b illustrate side views of an example fastening assembly 100 configured to form a blind connection between a first panel 102 and a second panel 104. The first panel 102 and the second panel 104 may be, for example, automotive panels. Depending on the application, the first panel 102 and the second panel 104 may be fabricated from, for example, metal (or a metal alloy), synthetic or semi-synthetic polymers (e.g., plastics, such as acrylonitrile butadiene styrene (ABS) and polyvinyl chloride (PVC), etc.), composite materials (e.g., fiber glass), or a combination thereof. In the automotive industry, example first panels 102 include, without limitation, door trim panels, moldings, trim pieces, and other substrates (whether used as interior or exterior surfaces).

The first panel 102 may define an A-surface 102a and a B-surface 102b (illustrated as an undersurface). The A-surface 102a, also called a class A surface, is typically the surface that is visible after assembly and, for that reason, is more aesthetically pleasing (e.g., textured, coated, or otherwise decorated) and typically free of attachment devices and/or related features. Conversely, the B-surface 102b, also called a class B surface, is typically the surface that is not visible after assembly and typically includes various attachment devices and/or related features.

As illustrated in FIG. 1a, the fastening assembly 100 generally comprises a first fastener component 106 and a second fastener component 108. As illustrated, the first fastener component 106 is attached to the B-surface 102b and, depending on the material type, may be attached to the B-surface 102b after fabrication of the first panel 102 (e.g., using adhesive or an mechanical attachment method, such as a doghouse interface). In one example, a top, planar portion of the first fastener component 106 may be adhesively secured to the first panel 102.

The second fastener component 108 is configured to attach to the second panel 104, embed in the second panel 104, or pass through at least a portion of the second panel 104. The second panel 104 may be, for example, a structural component of a vehicle, such as doors, pillars (e.g., an A-pillar, B-pillar, C-pillar, etc.), dashboard components (e.g., a cross member, bracket, frame, etc.), seat frames, center consoles, fenders, sheet metal framework, or the like. Upon assembly, as best illustrated in FIG. 1b, the second panel 104 is covered at least partially by the first panel 102.

Depending on the material type, the second fastener component 108 may be formed in or on the second panel 104 during molding or layup of the second panel 104, or attached after fabrication (e.g., inserted or clipped into an opening formed in the second panel 104). For example, when the second fastener component 108 is configured as a grommet, the grommet can be snapably secured within an opening formed in the second panel 104. The opening formed in the second panel 104 may be generally circular and define a size and shape that is complementary to that of the second fastener component 108 such that the second fastener component 108 can be inserted and retained therein. However, openings of other shapes are contemplated.

In the illustrated examples, the fastening assembly 100 is configured as a pin and grommet (P&G) fastener with a seal. Specifically, the first fastener component 106 is illustrated as including a pin and the second fastener component 108 is illustrated as a grommet configured to engage an opening formed in the second panel 104. When assembled, the pin is secured within the grommet. To the end, the grommet includes an opening or other structure that allows the pin to pass through during a mating process. The opening typically conforms to the shape of the pin shaft when the pin is secured with respect to the grommet. As such, the pin is not allowed to shift with respect to the grommet.

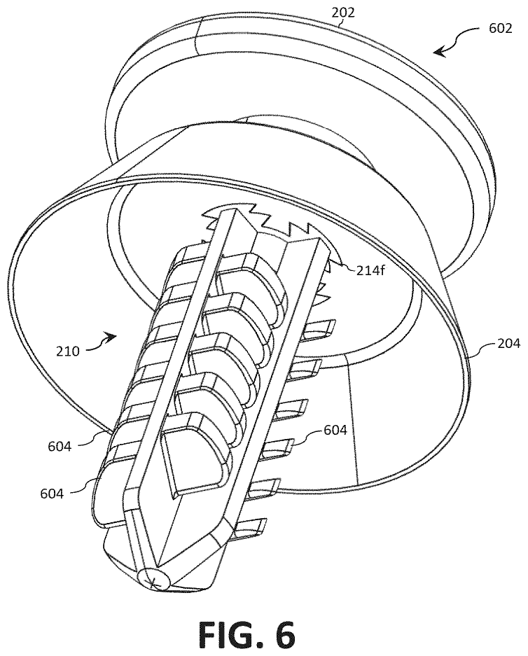

While the present disclosure will be generally described in connection with a P&G fastener, the teachings of the present disclosure, such as those directed to the integrated seal, may be applied to other types of fasteners where a seal is desired, including, for example, push pin fasteners, a box-prong fastener, clips, specialty fasteners (e.g., a CenterLok™ fastener, which is available from Deltar®), etc. For example, a tree fastener 600 is illustrated in FIG. 6. Further, while a blind connection will be described primarily, it is to be understood, however, that the teachings of the present disclosure may be adapted for use with structures other than the illustrated first and second panel 102, 104 that do not require the blind connection described. Accordingly, the present teachings are not to be limited to only blind connections. Finally, while only a single fastening assembly 100 illustrated in the examples, it should be appreciated that multiple fastening systems 100 may be used to couple a first panel 102 to a second panel 104, depending on the number of fastener points needed between the first and second panels 102, 104. For example, larger panels typically require multiple fastener points.

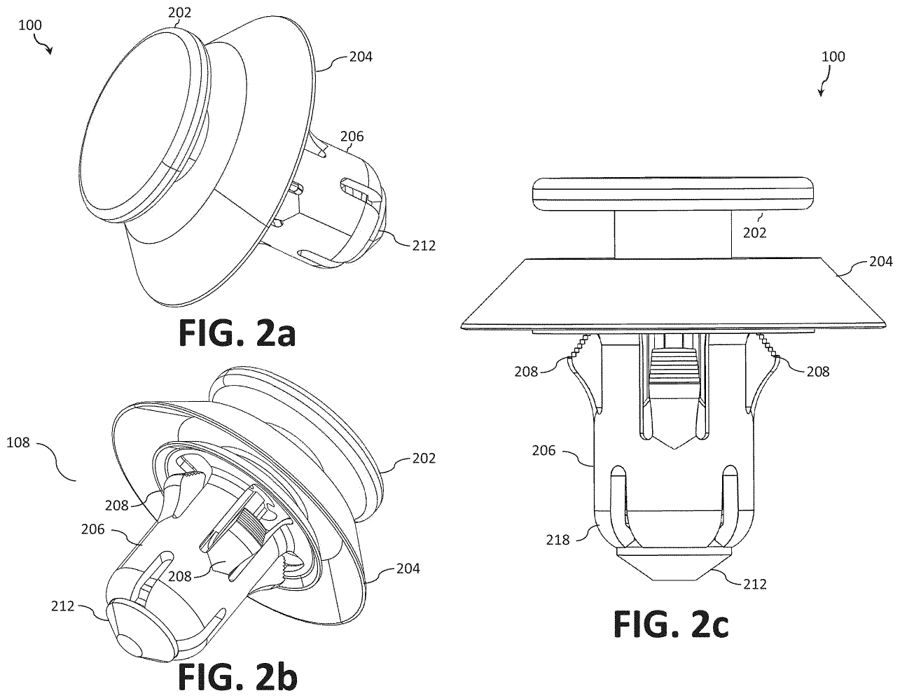

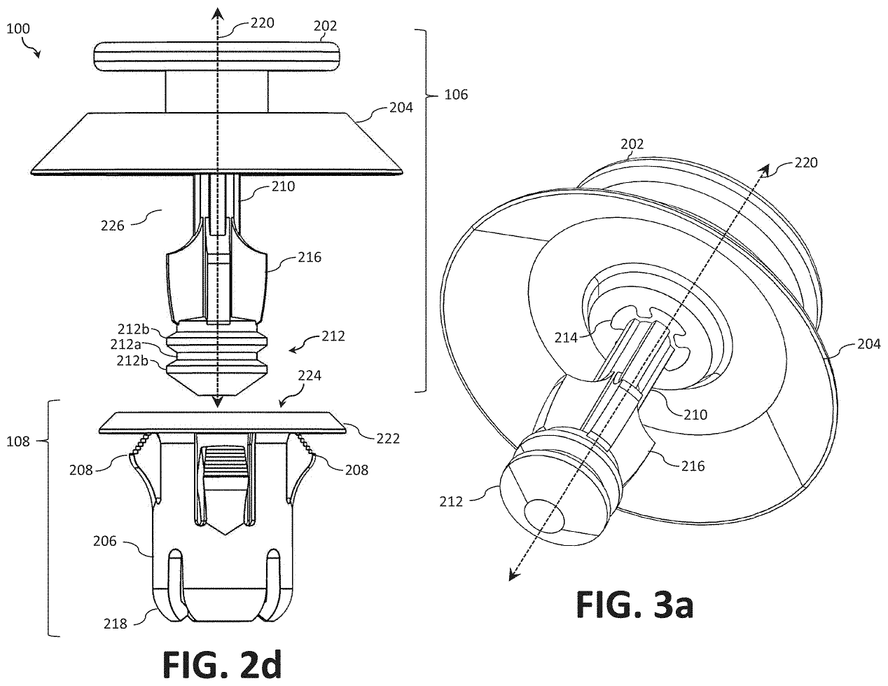

FIGS. 2a and 2b illustrate isometric views of the fastening assembly 100 in an assembled position, while FIG. 2c illustrates a side view of the fastening assembly 100 in an assembled position. For clarity, the first panel 102 and the second panel 104 are omitted to better illustrate the fastening assembly 100. FIG. 2d illustrates an assembly view of the fastening assembly 100 (i.e., in a disassembled position).

As illustrated, fastening assembly 100 generally comprise a first fastener component 106 (e.g., a male component) and a second fastener component 108 (e.g., a female component). In practice, the second fastener component 108 is configured to secure the first fastener component 106 relative to the second fastener component 108. In some examples, the first fastener component 106 generally comprising a rigid part component 226 (illustrated as a pin) and a flexible seal 204 to provide a sealed connection. In the illustrated example, the rigid part component 226 is illustrated as a pin having a head portion 202 and a shaft portion 210 that defines a longitudinal axis 220, whereas the second fastener component 108 generally comprises a housing 206 and a collar 222.

In some examples, the head portion 202 defines a planar portion (e.g., a surface), which may be attached to the first panel 102. The head portion 202 may be attached to the first panel 102 using, for example, an adhesive. The shaft portion 210 includes a tip 212 at its distal end and defines a longitudinal axis 220 between the head portion 202 and the tip 212. The housing 206 is illustrated as generally cylindrical and configured to be embedded within the second panel 104, while the collar 222 resides at the outer surface of the second panel 104.

The flexible seal 204 is integral with the rigid part component 226 to form the first fastener component 106. As illustrated, the flexible seal 204 is integrated with the rigid part component 226 adjacent the head portion 202 and surrounds the shaft portion 210. In some examples, the flexible seal 204 is fabricated from a first material and the rigid part component 226 is fabricated from a second material and that is different from the first material.

The tip 212 of the shaft portion 210 includes or otherwise defines one or more features configured to engage one or more corresponding features on the second fastener component 108. In the illustrated example, the tip 212 includes an annular valley 212a defined between two annular rings 212b about the longitudinal axis 220 and configured to engage one or more pawls 218 on the second fastener component 108.

One or more ribs 216 may be positioned on the shaft portion 210 along the longitudinal axis 220 between the flexible seal 204 and the tip 212. The one or more ribs 216 extend radially from the longitudinal axis 220 and are configured to engage one or more features on the second fastener component 108, such as the one or more retention wings 208.

The housing 206 defines an interior cavity configured to receive the tip 212 and at least a portion of the shaft portion 210, whereas the collar 222 defines an opening 224 configured to secure the first fastener component 106 relative to the second fastener component 108. The housing 206 is configured to engage the first fastener component 106 and/or the second panel 104 via one or more retention wings 208 and/or the one or more pawls 218. For example, inserting the first fastener component 106 into the housing 206 pushes the one or more retention wings 208 outward from the longitudinal axis 220, thereby pushing against the second panel 104. When assembled, the one or more pawls 218 snap within the annular valley 212a thereby mitigating movement of the shaft portion 210 out of the opening 224.

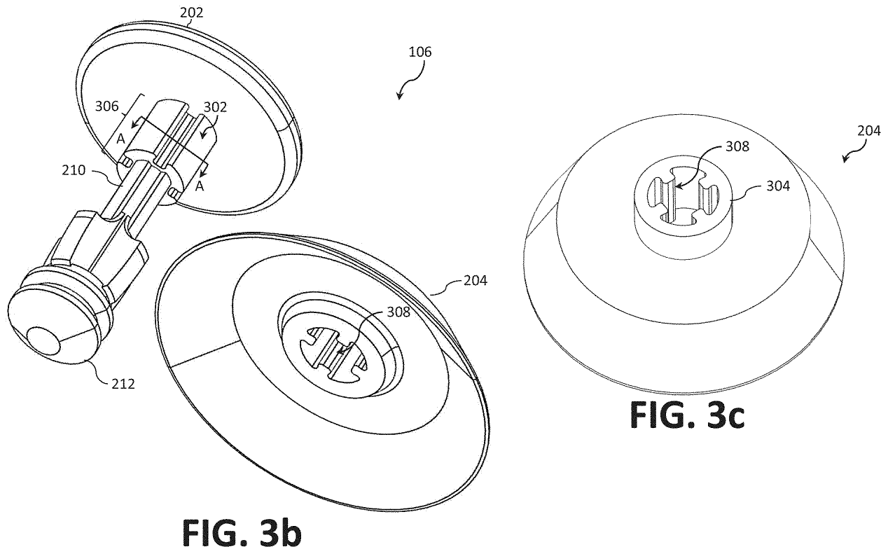

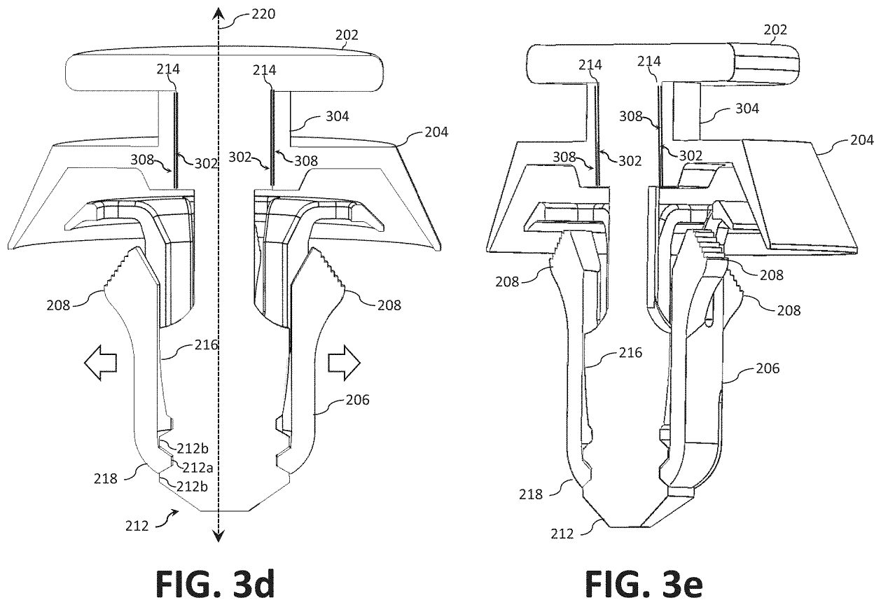

FIG. 3a illustrates a bottom isometric view of the first fastener component 106, while FIG. 3b illustrates a bottom isometric view of the shaft portion 210 of the first fastener component 106 with the flexible seal 204 removed. Finally, FIG. 3c illustrates a top isometric view of the flexible seal 204. In practice, the flexible seal 204 is integral with the rigid part component 226 (i.e., permanently attached) and positioned adjacent the head portion 202 to surround a linear segment 306 of the shaft portion 210 as illustrated in FIG. 3a; however, for ease of illustration, the flexible seal 204 is illustrated separately in FIGS. 3b and 3c.

The flexible seal 204 is fabricated from a first material, while the rigid part component 226 (e.g., the head portion 202 and the shaft portion 210) is fabricated from a second material that is different from the second material. That is, some materials are more conducive for sealing than mechanical attachment. In some examples, the first material may be a pliable and/or conformable seal material, such as a foam material, an elastomeric material (e.g., a thermoplastic elastomer (TPE)), a rubber material (e.g., open cell rubber, closed cell rubber, natural rubber, synthetic rubber, etc.), and the like. The second material is a part material that is generally rigid, such as synthetic or semi-synthetic polymers, composite materials, or a combination thereof. Example part materials include, inter alia, nylon (PA), polyetherimide (PEI), polyoxymethylene (POM), polypropylene (PP), high-density polyethylene (HDPE), acrylonitrile butadiene styrene (ABS), polystyrene (PS), and the like.

As best illustrated in FIG. 3a, the flexible seal 204 is attached to the rigid part component 226 at an interface 214. The connection between the flexible seal 204 and the rigid part component 226 at the interface 214 must be adequate to prevent the flexible seal 204 from detaching from the rigid part component 226 prior to, during, and/or post installation by the end user. As can be appreciated, some applications require a small first fastener component 106; however, reducing the physically size of the first fastener component 106 would decrease the size of the rigid part component 226 and, therefore, the size of the interface 214. A reduction in contact area between the flexible seal 204 and the rigid part component 226 at the interface 214 reduces the connection strength therebetween.

To provide an adequate connection while also providing a small first fastener component 106 (or to increase the connection strength, where desired), the interface 214 can use a non-circular cross-section and/or one of more engagement features (e.g., a complex profile and/or complex features, such as lobes) to increase the contact area between the flexible seal 204 and the rigid part component 226 at the interface 214. A non-circular cross-section and/or one of more engagement features offers a number of advantages. First, a non-circular cross-section can increase the contact surface area between the between the flexible seal 204 and the rigid part component 226, thus increasing the adhesive retention at the interface 214. Second, a non-circular cross-section can be shaped to include engagement features, thus providing a higher degree of mechanical retention. For example, the flexible seal 204 and/or the rigid part component 226 may be shaped to form an interface 214 having one or more interlocking features to increase mechanical retention. Example interlocking features include, inter alia, lobes, dovetails, etc.

These improvements at the interface 214 increase the retention of the flexible seal 204 to the rigid part component 226 (or other component of the first fastener component 106, as applicable) and improves the sealing performance of the flexible seal 204, while also permitting a smaller overall size. In the illustrated example, the flexible seal 204 is configured to surround a linear segment 306 of the shaft portion 210; however, other locations are possible depending on the design needs. Further, while the flexible seal 204 is illustrated as a circular gasket, it is contemplated that the shape of the flexible seal 204 may be modified in size and/or shape to suit individual applications.

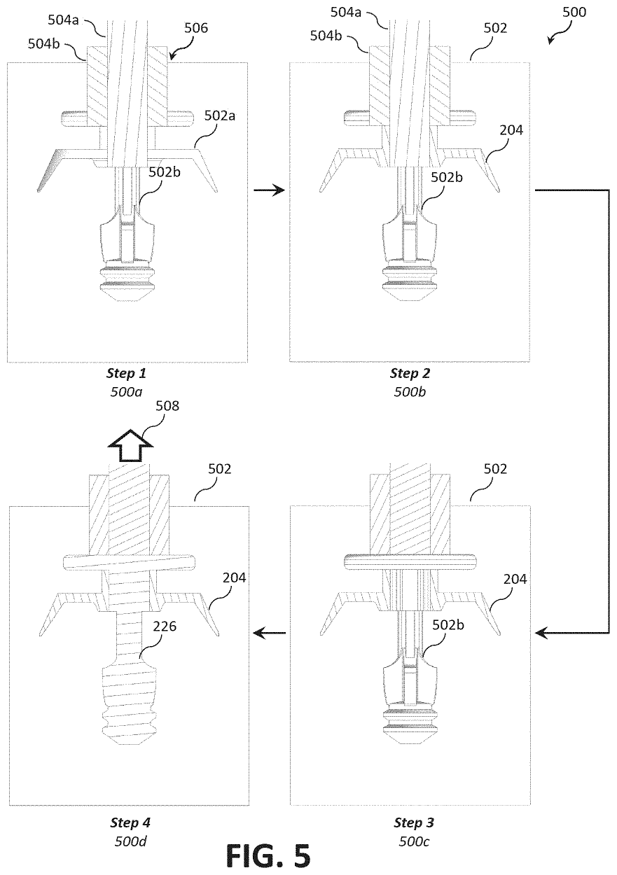

To form the interface 214 with a non-circular cross-section, one of the flexible seal 204 or the rigid part component 226 can be first molded to provide the desired profile, after which the other of the flexible seal 204 or the rigid part component 226 may be molded. In some examples, as will be discussed in connection with FIG. 5, the rigid part component 226 and the flexible seal 204 are fabricated via a two-shot injection process. An example two-shot injection process is described in commonly owned U.S. Pat. No. 6,752,950 to Martin D. H. Clarke, which is entitled “Two Shot Molding Method And Fastener Clip With Seal Made Thereby.” In other examples, the flexible seal 204 is over-molded onto the shaft portion 210 of the rigid part component 226.

As best illustrated in FIG. 3b, the outer interface surface 302 of the linear segment 306 and the inner interface surface 308 of the flexible seal 204 collectively define the non-circular cross-section of the interface 214. For example, the flexible seal 204 can form or otherwise define a collar 304 that bonds with the rigid part component 226 (e.g., at the linear segment 306). The first component to be molded will, in effect, be used to mold the other component. The order in which the flexible seal 204 and the rigid part component 226 are molded will depend on the manufacturing technique employed. For example, in a two-shot injection process, as will be discussed, the flexible seal 204 is molded first, and the rigid part component 226 is molded second. Using a two-shot injection process, as will be discussed, allows for a complex interface 214 (e.g., an interface 214 with one or more dovetails) to be more efficiently molded. In an over-molding process, the rigid part component 226 would be molded first, and the flexible seal 204 molded second.

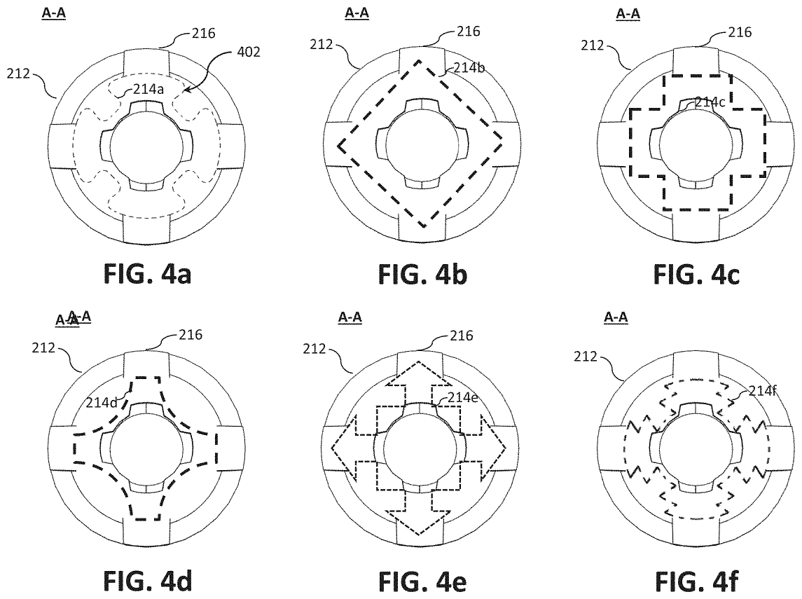

FIGS. 4a through 4f illustrate example non-circular cross-sections (A-A) for the interface 214 of the first fastener component 106 in accordance with aspects of this disclosure. Specifically, FIGS. 4a through 4f illustrate example cross-sectional views of the linear segment 306 taken along the cut line A-A illustrated in FIG. 3b.

FIG. 4a illustrates a non-circular cross-section comprising or otherwise defining a plurality of lobes 402 (four are illustrated) arranged in a clover formation 214a. While four lobes 402 are illustrated and described primarily, it is to be understood, however, that any number of lobes 402 may be provided to achieve a desired shape and/or strength at the interface 214. For example, including additional lobes 402 would increase the amount of surface area (as well a complexity of the shape) at the interface 214, thereby increasing the strength of the bond/connection between the rigid part component 226 and the flexible seal 204. Where the strength of the bond/connection between the rigid part component 226 and the flexible seal 204 need not be as strong, fewer lobes 402 may be employed.

In the illustrated example, each lobe 402 is shaped with an undercut to form a dovetail (e.g., a wedge-shaped lobe with a reverse-taper). Therefore, in one example, the non-circular cross-section comprises or otherwise defines at least one dovetail that provides interlocking connection between the flexible seal 204 and the rigid part component 226 at the interface 214. In some examples, the profile of the lobe 402 (or other feature) also forms a longitudinal taper along the longitudinal axis 220 such that the size or shape of the lobe 402 changes in size or shape along the longitudinal axis 220. Such a taper would mitigate pullout of the rigid part component 226 from the flexible seal 204 (e.g., a pullout force in a direction parallel to the longitudinal axis 220).

While a dovetail is described primarily, it is to be understood, however, that the non-circular cross-section may be configured with other shapes. For example, the non-circular cross-section may be a quadrilateral shape 214b (e.g., squares, rectangles, etc.) as illustrated in FIG. 4b, a cross shape 214c as illustrated in FIG. 4c (illustrated as an X-shaped cross), a plaque shape 214d as illustrated in FIG. 4d, a complex shapes as illustrated in FIGS. 4e and 4f (illustrated as a quad arrow 214e and saw-toothed cross 214f, respectively), and/or other shapes, such as a triangular shape, ovals, etc. A can be appreciated, a more complex shape increased the connection strength as a result of the increase surface area and the entwined connection of the first material of the flexible seal 204 and the second material of the rigid part component 226.

FIG. 5 illustrates an example method 500 for forming a fastener assembly 106 with an integrated flexible seal 204 using a molding tool 502 during a two-shot (or two-step) manufacturing process. In some examples, the molding tool 502 defines two or more cavities and includes an injection core assembly 504. Each of the two or more cavities may correspond to a different component or portion of the fastener assembly 106. For examples, a seal cavity 502a corresponds to a flexible seal 204 and a part cavity 502b corresponds to a rigid part component 226. The usual vents and other standard conduits necessary or useful for molding are not shown for the purposes of clarity.

The molding tool 502 also has a bore 506 adapted to permit the injection core assembly 504 to slide within bore 506. The injection core assembly 504 is configured to open and close flow communication between the two or more cavities using an inner core pin 504a (e.g., a slide pin) and one or more outer core pins 504b (e.g., one or more sleeves). Movement of inner core pin 504a and one or more outer core pins 504b is individually controlled either hydraulically or electrically as part of the molding process and the selective control of molding core pins 504a, 504b is known in the technology and therefore further details of the control system is not shown or set forth.

At step 1 500a, the molding tool 502 is closed, and the inner core pin 504a and one or more outer core pins 504b are moved to a first position.

In the first position, the seal cavity 502a is temporarily closed off from the part cavity 502b to prevent flow communication between the part cavity 502b and the seal cavity 502a.

At step 2 500b, a first shot of a first material is injected into the seal cavity 502a to form the flexible seal 204. As explained above, the first material using to form the flexible seal 204 may be, for example, a pliable and/or conformable seal material. As can be appreciated, the injection core assembly 504 (e.g., the one or more outer core pins 504b) may be shaped to function as the part of the molding tool 502 that yields the desired profile of the inner interface surface 308 of the flexible seal 204. For example, the surface of the injection core assembly 504 positioned at the interface 214 is shaped to define at least one engagement features at an inner interface surface 308 at the collar 304 of the flexible seal 204, such as a lobe, dovetail, etc.

At step 3 500c, the inner core pin 504a and one or more outer core pins 504b of the injection assembly 504 are moved to a second position. In the second position, the seal cavity 502a is now open to the part cavity 502b.

At step 4 500c, a second shot of a second material is injected into the part cavity 502b to form the rigid part component 226, which includes the new shared walls of the flexible seal 204. The second material flows from the part cavity 502b into intimate contact with the inner interface surface 308 of the flexible seal 204 as molded at step 2 to form an interface 214 between the rigid part component 226 and the flexible seal 204. Accordingly, the second material conforms and adheres to inner interface surface 308 of the flexible seal 204. As explained above, the second material may be, for example, a part material.

In some examples, a fifth step may be performed where the inner core pin 504a and one or more outer core pins 504b are moved into a release position (a third position). In third position, the fastener component may be easier to eject from the molding tool 502. For example, the inner core pin 504a and one or more outer core pins 504b may be withdrawn from the bore 506 of molding tool 502 as indicated by arrow 508. While only a single outer core pin 504b is illustrated in FIG. 5, multiple outer core pins 504b may be employed to form more complicated shapes.

Accordingly, the molding tool 502 is designed so that the first shot or step is the injection of the first material with the injection core assembly 504 blocking off material flow to all portions of the part cavity 502b so that material flow of selected first material into the mold initially forms the flexible seal 204. Then the injection core assembly 504 are withdrawn and the rigid portion of the fastener assembly 106, including the head portion 202 and the shaft portion 210, are molded with different material without removing the molded flexible seal 204 from the molding tool 502. The second material is injected in effect through the collar 304 of the flexible seal 204, the inner periphery of the collar 304 defining a passageway for material to flow between the head portion 202 and the shaft portion 210. By shaping the molding tool 502 (e.g., the injection core assembly 504) to form a non-circular cross-section at the inner periphery of the collar 304, the strength of the interface 214 is increased to yield a smaller, very effective fastener that can be formed from a two-shot or two-step molding technique.

FIG. 6 illustrates a bottom isometric view of a tree fastener 602. The seal 204 and method of fabricated of the tree fastener 602 are substantially the same as described in connection with the fastener component 106 of FIGS. 2a through 2d, but rather than define a pin-type fastener, the shaft portion 210 defines a plurality of ribs 604 that engage the second panel 104 (whether directly or via a second fastener component). The plurality of ribs 604 may be arranged in one of an R-ratchet configuration, an X configuration, or P configuration. Additionally, the non-circular cross-section is illustrated as a saw-toothed cross 214f.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed:

1. A fastener assembly for forming a sealed connection between a first panel and a second panel, the fastener assembly comprising:
a rigid part component configured to retain the second panel relative to the first panel,
wherein the rigid part component is fabricated from a part material and comprises a head portion configured to engage the first panel and a shaft portion extending from the head portion; and
a flexible seal that is integral with the rigid part component and positioned at an interface adjacent the head portion to surround the shaft portion,
wherein the flexible seal is fabricated from a seal material that is different from the part material, and
wherein the interface defines a non-circular cross-section.

2. The fastener assembly of claim 1, wherein the rigid part component and the flexible seal are fabricated to form the fastener assembly via a two-shot injection process.

3. The fastener assembly of claim 2, wherein the rigid part component conforms to and bonds with an inner interface surface of the flexible seal to define the interface.

4. The fastener assembly of claim 1, wherein the flexible seal is over-molded onto the rigid part component to form the fastener assembly.

5. The fastener assembly of claim 4, wherein the flexible seal conforms to and bonds with an outer interface surface of the rigid part component to define the interface.

6. The fastener assembly of claim 1, wherein the non-circular cross-section includes at least one lobe.

7. The fastener assembly of claim 6, wherein the at least one lobe is a dovetail.

8. The fastener assembly of claim 6, wherein the at least one lobe forms a longitudinal taper in a direction along a longitudinal axis defined by the shaft portion.

9. The fastener assembly of claim 1, wherein the rigid part component is configured to engage the second panel via a second fastener component coupled thereto.

10. The fastener assembly of claim 9, wherein the second fastener component is a grommet configured to engage an opening formed in the second panel.

11. The fastener assembly of claim 9, wherein the rigid part component is a pin.

12. A method of fabricating a fastener assembly using a molding tool having at least a part cavity defining a configuration of a rigid part component and a seal cavity defining a configuration of a flexible seal that are initially in flow communication with one another, the method comprising:
temporarily closing off flow communication between said part cavity and said seal cavity via an injection core assembly, wherein the injection core assembly is configured to open and close flow communication between said part cavity and said seal cavity;
injecting a first material into said seal cavity to mold the flexible seal of said fastener assembly, wherein the injection core assembly is shaped to define at least one lobe at an inner interface surface of the flexible seal;
opening flow communication between said part cavity and said seal cavity via the injection core assembly;
injecting a second material into said part cavity to form the rigid part component, said second material flowing from the part cavity into intimate contact with the inner interface surface of the flexible seal as molded to form an interface between the rigid part component and the flexible seal; and
ejecting said fastener assembly from the molding tool, wherein said fastener assembly as molded has parts of different materials molded sequentially together.

13. The method of claim 12, wherein the at least one lobe is a dovetail.

14. The method of claim 12, wherein the at least one lobe forms a longitudinal taper in a direction along a longitudinal axis defined by a shaft portion of the rigid part component.

15. The method of claim 12, wherein the first material is a foam material or an elastomeric material.

16. The method of claim 15, wherein the second material is a rigid synthetic or semi-synthetic polymer material.

17. A pin and grommet (P&G) fastener for forming a sealed connection between a first panel and a second panel, the P&G fastener comprising:
a grommet; and
a fastener assembly comprising a rigid part component and a flexible seal that is integrally coupled with the rigid part component at an interface,
wherein the flexible seal is fabricated from a first material and the rigid part component is fabricated from a second material that is different from the first material,
wherein the rigid part component configured to retain the second panel relative to the first panel via the grommet, and
wherein the interface defines one or more dovetails to interlock the flexible seal with the rigid part component.

18. The P&G fastener of claim 17, wherein the fastener assembly comprises a head portion configured to engage the first panel and a shaft portion extending from the head portion.

19. The P&G fastener of claim 18, wherein the flexible seal is positioned adjacent the head portion to surround the shaft portion,

20. The P&G fastener of claim 17, wherein the rigid part component and the flexible seal are fabricated to form the fastener assembly via a two-shot injection process.
